(19) United States
(12) Patent Application Publication
(10) Pub. No.: US 2016/0017448 A1
(43) Pub. Date: Jan. 21, 2016

(54) SOFT MAGNETIC COMPONENT STEEL MATERIAL HAVING EXCELLENT PICKLING PROPERTIES, SOFT MAGNETIC COMPONENT HAVING EXCELLENT CORROSION RESISTANCE AND MAGNETIC PROPERTIES, AND PRODUCTION METHOD THEREFOR

(71) Applicant: KABUSHIKI KAISHA KOBE SEIKO SHO(KOBE STEEL, LTD.), Kobe-shi, Hyogo (JP)

(72) Inventor: Kei MASUMOTO, Kobe-shi (JP)

(73) Assignee: Kabushiki Kaisha Kobe Seiko Sho (Kobe Steel, Ltd.), Kobe-shi, Hyogo (JP)

(21) Appl. No.: 14/775,226

(22) PCT Filed: Mar. 25, 2014
(86) PCT No.: PCT/JP2014/058282

§ 371 Date: Sep. 11, 2015

(30) Foreign Application Priority Data
Mar. 29, 2013 (JP) 2013-074949

(51) Int. Cl. C21D 1/26; C22C 38/58; C22C 38/42; C22C 38/40; C22C 38/34; H01F 1/16; C22C 38/06; C22C 38/04; C22C 38/02; C22C 38/00; C21D 8/12; C22C 38/60; C22C 38/20

(52) U.S. Cl. CPC C21D 1/26; C22C 38/60; C22C 38/58; C22C 38/42; C22C 38/40; C22C 38/34; C22C 38/20; C22C 38/06; C22C 38/04; C22C 38/02; C22C 38/004; C22C 38/002; C22C 38/001; C21D 8/12; H01F 1/16

(57) ABSTRACT

Provided is a steel material for soft magnetic components, having excellent pickling properties and capable of achieving excellent magnetic properties and corrosion resistance in a final component. The steel material for soft magnetic components comprises, in % by mass, 0.001%-0.025% C, more than 0% but less than 1.0% Si, 0.1%-1.0% Mn, more than 0% but no more than 0.030% P, more than 0% but no more than 0.08% S, more than 0% but less than 0.5% Cr, more than 0% but no more than 0.010% Al, and more than 0% but no more than 0.01% N, with the remainder being iron and unavoidable impurities; and is characterized by having a rolled scale including 40-80 vol % FeO being formed on the steel material surface.

### TECHNICAL FIELD

The present invention relates to a steel material for soft magnetic component with excellent pickling property, a soft magnetic component having excellent corrosion resistance and magnetic properties, and a production method therefor.

### BACKGROUND ART

Conforming to energy saving in automobiles, etc. electromagnetic components of the automobiles, etc. capable of realizing precise control for magnetic circuits and provision of electric power saving and improvement of magnetic response speed are demanded. Accordingly, steel materials as the materials for the electromagnetic components are required to provide properties such as easy magnetization at low external magnetic field and having small coercive force as magnetic properties.

As the steel material described above, soft magnetic steel material in which the magnetic flux density inside the steel material tends to respond to the external magnetic field is usually used. For the soft magnetic steel material, for example, extremely low carbon steel at the amount C of about 0.1 mass % or less (pure iron based soft magnetic material), etc. is used specifically. The electromagnetic component (hereinafter sometimes referred to also as a soft magnetic component) is generally obtained by subjecting the steel material to hot rolling and then applying pickling, lubrication film coating and wire drawing referred to as secondary processing step to obtain a steel wire, which is then applied with component forming, magnetic annealing, etc. successively.

By the way, the soft magnetic component is required to have corrosion resistance depending on the operation environments. An electromagnetic stainless steel is used to a portion required for high corrosion resistance. The electromagnetic stainless steel is one of the special steels having both magnetic properties and corrosion resistance together and the application use includes soft magnetic components utilizing magnetic circuits for which suppression of eddy current is indispensable such as injectors, sensors, actuators, and motors, and soft magnetic components used in corrosive environments. As the electromagnetic stainless steel, 13Cr series electromagnetic stainless steels have been often used so far and, for example, Patent Literature 1 proposes a technique of improving the cold forgeability and machinability of the 13Cr series electromagnetic stainless steels. However, the 13Cr series electromagnetic stainless steels are less workable compared to extremely low carbon steel with more excellent cold forgeability and, further, the material cost goes up due to high content of alloying elements to involve a problem that the material cost increases in conjunction with the sudden price rise of the alloy cost, or availability of materials becomes difficult.

On the other hand, for the extremely low carbon steel, some techniques have been proposed, for example, in Patent Literature 2 or Patent Literature 3. They are provided mainly intending to improve the strength and the machinability without deteriorating the magnetic properties by controlling the steel chemical components or dispersed state of sulfides in the steel material, but they did not study as far as the cases where corrosion resistance is required.

By the way, when corrosion-resistant elements (alloying elements) are increased in order to improve the corrosion resistance, scales are less removed by pickling (descaling with acid) in a secondary processing step using the rolled material to deteriorate the productivity and increase the environmental load such as increase of the pickling time and requirement of re-pickling. Steel materials having much corrosion-resistant improving elements include stainless steels such as SUS 430 (17% Cr) and SUS 304 (18% Cr, 8% Ni), but rolling scales are less removed therefrom with acid.

### CITATION LIST

### Patent Literature

Patent Literature 1: Japanese Unexamined Patent Application Publication No. H06(1994)-228717
Patent Literature 2: Japanese Unexamined Patent Application Publication No. 2010-235976
Patent Literature 3: Japanese Unexamined Patent Application Publication No. 2007-046125

### SUMMARY OF INVENTION

### Technical Problem

The present invention has been accomplished in view of the situations described above and it intends to provide a steel material from which a rolling scale formed on the surface of the rolled material tends to be removed easily in a descaling step by a chemical method using an acid (pickling step) (hereinafter, the property is referred to as “pickling property”) and which can provide excellent magnetic properties and corrosion resistance in final components (soft magnetic components, electromagnetic components), and soft magnetic components with excellent corrosion resistance and magnetic properties obtained by using the steel material, as well as a method of producing a soft magnetic component.

### Solution to Problem

The steel material for a soft magnetic component with excellent pickling property of the present invention capable of solving the subject described above is characterized by satisfying:

C: 0.001 to 0.025% (mass % which is identical hereinafter for chemical components),
Si: more than 0% and less than 1.0%,

### Mn: 0.1 to 1.0%,

P: more than 0% and 0.030% or less
   S: more than 0% and 0.08% or less,
   Cr: more than 0% and less than 0.5%,
   Al: more than 0% and 0.010% or less, and
   N: more than 0% and 0.01% or less, with
   the remainder consisting of iron and inevitable impurities in which a rolling scale containing 40 to 80 vol % of FeO is formed on the surface of the steel material.

The steel material for the soft magnetic component may further contain, as other elements,

(a) one or more elements selected from the group consisting of Cu: more than 0% and 0.5% or less and Ni: more than 0% and 0.5% or less, and

(b) Pb: more than 0% and 1.0% or less.

The present invention also includes a soft magnetic component with excellent corrosion resistance and magnetic properties obtained by using the steel material for the soft magnetic component characterized in that an oxide film of 5 to 30 nm thickness is formed on the surface of the component.

Further, the present invention also includes a method for producing s soft magnetic component. The production method is characterized by forming a component using the steel material for the soft magnetic component and then applying annealing under the following conditions:

### (Annealing Condition)

Annealing atmosphere: 1.0 ppm by volume of oxygen concentration, Annealing temperature: 600 to 1200° C., and Annealing time: One hour or more but 20 hours or less.

### Advantageous Effects of Invention

According to the present invention, a steel material showing magnetic properties and corrosion resistance equivalent to those of a case using an electromagnetic stainless steel can be realized at a reduced cost including material and processing cost.

### DESCRIPTION OF EMBODIMENTS

The present inventor has made earnest studies for solving the subject. As a result, it has been found that a steel material with excellent pickling property (steel material for soft magnetic component) is obtained by forming a rolling scale containing much FeO to the surface of the steel material as will be described specifically below.

A rolling scale formed by hot rolling is formed in a layered configuration in the order of FeO, Fe₃O₄ and Fe₂O₃ successively from the side of the raw material. Referring to their acid solubility, FeO is soluble and Fe₃O₄ and Fe₂O₃ are less soluble. That is, as FeO is contained by more amount in the rolling scale, the rolling scale tends to be dissolved by the acid. Further, in the rolling scale, there are many fine cracks or pores due to the heat shrink of the scale during cooling. The acid solution passes through them and reaches the soluble FeO layer to dissolve the scale, as well as a local cell is formed in the FeO layer with Fe being an anode and Fe₃O₄ being a cathode by coprecipitation transformation, the scale can be peeled mechanically.

In the present invention, a rolling scale containing 40 vol % or more of FeO is formed on the surface of a steel material in order to sufficiently provide the effect due to FeO described above thereby ensuring the excellent pickling property. FeO is preferably 45 vol % or more and more preferably 50 vol % or more. From the viewpoint of ensuring a good pickling property, it is more preferable as the amount of FeO is larger. While FeO is theoretically 100% by volume, it is difficult to decrease other components than FeO to 0% by volume with a viewpoint of industrial production and the upper limit for the amount of FeO is 80% by volume.

Further, if the thickness of the rolling scale is excessively large, the pickling time is made longer even when the chemical composition of the rolling scale is controlled so as to satisfy the definition described above. Accordingly, the thickness of the rolling scale is preferably 100 μm or less. It is more preferably 50 μm or less and further preferably, 30 μm or less. With a viewpoint of intending to obtain a higher pickling property, the rolling scale is preferably as thin as possible. While it may be extremely thin so that the descaling effect due to FeO is provided, it is difficult to decrease the thickness of the rolling scale to 0 μm, and the lower limit for the thickness of the rolling scale is about 1 μm.

The chemical composition of the steel material of the present invention is to be described below.

### [C: 0.001 to 0.025%]

C is an essential element for ensuring a mechanical strength and, if the amount is small, it can increase the electric resistance to suppress deterioration of magnetic properties caused by eddy current. However, C is solid solubilized in a steel to distort Fe crystal lattice, therefore if the C content increases, the magnetic properties are deteriorated remarkably. Further, if the amount of C is remarkably excessive, corrosion resistance is sometimes deteriorated. Accordingly, the amount of C is defined to 0.025% or less. The amount of C is preferably 0.020% or less, more preferably, 0.015% or less and, further preferably, 0.010% or less. Since the effect of improving the magnetic properties is saturated even when the amount of C is decreased to less than 0.001%, the lower limit for the amount of C is defined to 0.001% in the present invention.

[Si: More than 0% and Less than 1.0%]

Si is an element that acts as a deoxidizing agent during steel melting and provides an effect of increasing the electric resistance to suppress the deterioration of the magnetic properties caused by eddy current. Further, Si is also an element of strengthening the oxide film to improve the corrosion resistance. With such viewpoints, Si may be contained by 0.001% or more. However, when Si is contained in a great amount, less soluble Fe₂SiO₄ is formed in the rolling scale to deteriorate the pickling property. Accordingly, the amount of Si is defined to less than 1.0% in the present invention. The amount of Si is preferably 0.8% or less, more preferably, 0.5% or less, further preferably, 0.20% or less, further more preferably, 0.10% or less, and particularly preferably, 0.050% or less.

### [Mn: 0.1 to 1.0%]

Mn is an element that effectively acts as a deoxidizing agent and also an element that combines with S contained in the steel and dispersed finely as MnS precipitates to form a chip breakers and contribute to the improvement of the machinability. For effectively providing such effects, it is necessary that Mn is contained by 0.1% or more. The amount of Mn is preferably 0.15% or more and, more preferably, 0.20% or more. However, since excess amount of Mn increases the number of MnS which is deleterious to the magnetic properties, the upper limit is defined to 1.0%. The amount of Mn is preferably 0.8% or less, more preferably, 0.60% or less and, further preferably, 0.40% or less.

[P: More than 0% and 0.030% or Less]

P (phosphorus) is a harmful element that causes grain boundary segregation in the steel to give a negative effect on the cold forgeability and the magnetic properties. Accordingly, the amount of P is preferably restricted to 0.030% or less, thereby improving the magnetic properties. The amount of P is preferably 0.015% or less and, more preferably, 0.010% or less.

[S: More than 0% and 0.08% or Less]

S (sulfur) has a function of forming MnS in the steel as described above and forming stress concentration spots when stress is applied during cutting thereby improving the machinability. In order to effectively provide such an effect, S may be contained by 0.003% or more. It is more preferably 0.01% or more. However, excess amount of S increases the number of MnS which is deleterious to the magnetic properties. Further, since the cold forgeability is remarkably deteriorated, the amount of S is restricted to 0.08% or less. It is preferably 0.05% or less and, more preferably, 0.030% or less.

[Cr: More than 0% and Less than 0.5%]

Cr is an element that effectively increases the electric resistance in the ferrite phase thereby decreasing the damping time constant of eddy current. Further, it has an effect of lowering a current density in an active region of corrosion reaction thereby contributing to the improvement of the corrosion resistance. Further, since Cr is also an alloying element of strengthening a passivation film, it further strengthens the oxide film formed after annealing, thereby contributing to the improvement of the corrosion resistance. For providing such effects, Cr is contained preferably by 0.01% or more. More preferably, it is 0.05% or more. However, if Cr is contained in a great amount, slightly soluble FeCr₂O₄ is formed in the rolling scale to deteriorate the pickling property. Accordingly, the amount of Cr is defined to less than 0.5% in the present invention. The amount of Cr is preferably 0.35% or less, more preferably, 0.20% or less, further preferably, 0.15% or less and, furthermore preferably, 0.10% or less.

[Al: More than 0% and 0.010% or Less]

Al is an element that is added as a deoxidizing agent and has an effect of decreasing impurities along with deoxidization and improving the magnetic properties. In order to provide the effects, the amount of Al is preferably 0.001% or more and, more preferably, 0.002% or more. However, Al has an effect of fixing solid-solubilized N as AlN to refine the crystal grains. Accordingly, Al, if contained excessively increases crystal grain boundaries by refinement of the crystal grains to deteriorate the magnetic properties. Accordingly, in the present invention, the amount of Al is defined to 0.010% or less. In order to ensure more excellent magnetic properties, the amount of Al is preferably. 0.008% or less and, more preferably, 0.005% or less.

[N: More than 0% and 0.01% or Less]

As described above, N (nitrogen) is combined with Al into AlN and deteriorate the magnetic properties. In addition, N not combined with Al or the like remains as solid solubilized N in the steel, which also deteriorates the magnetic properties. Accordingly, the amount of N should be restricted as much as possible in any case. In the present invention, the upper limit of the amount of N is defined as 0.01%, which can restrict the disadvantage due to N to a substantially negligible extent while considering the actual operation of the steel material production. The amount of N is preferably 0.008% or less, more preferably, 0.0060% or less, further preferably, 0.0040% or less and, furthermore preferably, 0.0030% or less.

The basic components of the steel material for the soft magnetic component and the soft magnetic component according to the present invention are as described above, with the remainder consisting of iron and inevitable impurities. Intrusion of elements that may be introduced depending on the raw materials, consumables, production equipment, etc. is permitted as the inevitable impurities. Further, in addition to the elements described above, (a) one or more elements selected from the group consisting of Cu and Ni by the amount described below may be incorporated to further improve the corrosion resistance or (b) Pb in the amount described below may be contained to improve the machinability.

The elements described above are to be described specifically below.

[One or More Elements Selected from the Group Consisting of Cu: More than 0% and 0.5% or Less, and Ni: More than 0% and 0.5% or Less]

Cu and Ni are elements that improve the corrosion resistance by providing an effect of lowering a current density in an active region of corrosion reaction and an effect of strengthening an oxide film. For providing such effects, when Cu is contained, it is contained preferably by 0.01% or more and, more preferably, 0.10% or more. When Ni is contained, it is contained preferably by 0.01% or more and, more preferably, 0.10% or more. However, if such elements are contained excessively, slight soluble rolling scale is formed to deteriorate the pickling property, as well as cost for the alloy increases failing to provide the material inexpensively. Further, deterioration of the magnetic properties is also remarkable due to the lowering of the magnetic moment. Accordingly, the upper limit for each of Cu and Ni is preferably defined respective to 0.5% or less. More preferred upper limit of Cu and Ni is 0.35% or less, further more preferred upper limit is 0.20% or less respectively, and a furthermore preferred upper limit is 0.15% or less respectively.

[Pb: More than 0% and 1.0% or Less]

Pb has an effect of forming Pb particles in the steel and forming stress concentration points when stress is applied during cutting to improve the machinability and has a lubrication effect on the cut surface, since this is dissolved by heat generated upon fabrication during cutting. Accordingly, Pb is an element that is suitable to application use for which machinability is particularly required such as maintaining a high surface accuracy at the cut surface even in heavy cutting and also improving the chip treatability. For obtaining such effects, the amount of Pb is preferably 0.01% or more and, more preferably, 0.05% or more. However, since excess amount of Pb deteriorates the magnetic properties and the cold forgeability remarkably, it is preferred to restrict the amount to 1.0% or less. The amount of Pb is more preferably 0.50% or less and, furthermore preferably, 0.30% or less.

The present invention, also defines a soft magnetic component obtained by using the steel material. The soft magnetic component also satisfies the chemical composition described above. Further, the soft magnetic component is characterized in that an oxide film of 5 to 30 nm thickness is formed on the surface. The oxide film is to be described below.

In a stainless steel, excellent corrosion resistance is ensured by adding a great amount of alloying elements, for example, adding 11% or more of Cr, thereby forming a passivation film. However, addition of a great amount of alloying elements deteriorates the pickling property of the steel material as described above. Then, in the present invention, the oxide film of excellent corrosion resistance is formed by annealing not by relying on a great amount of alloying elements. Annealing is to be described later more specifically.

Among the components constituting the oxide film, a component particularly showing good corrosion resistance is Fe₃O₄. However, since the lattice constant of Fe₃O₄ is greatly different from the lattice constant of Fe as the base material, bonding strength is weak. Accordingly, as the thickness of the oxide film increases, adhesiveness between the oxide film and the base material is lowered and fine cracks tend to be formed between them. It is considered that when an aqueous solution intrudes into the formed cracks, a local cell with Fe₂O₄ as a positive electrode and with a base material Fe as an anode is formed to proceed with corrosion reaction and generate rust.

Then, the thickness of the oxide film is particularly noted in the present invention. Specifically, a relation between the thickness of the oxide film and the corrosion resistance was studied earnestly under the consideration that it is important to control the thickness of the oxide film thinly in order to improve the adhesiveness with the base material. As a result, it was found that if the thickness of the oxide film exceeds 30 nm, adhesiveness with the base material is lowered and fine cracks are formed failing to obtain excellent corrosion resistance. Accordingly, in the present invention, the thickness of the oxide film formed on the surface of the component is restricted to 30 nm or less. The thickness is preferably 25 nm or less, more preferably, 20 nm or less and, furthermore preferably, 15 nm or less. On the other hand, if the thickness of the oxide film is excessively thin, it is also difficult to ensure the corrosion resistance. In view of the above, in the present invention, corrosion resistance equivalent to that of the electromagnetic stainless steel is attained by controlling the thickness of the oxide film to 5 nm or more. The thickness of the oxide film is preferably 7 nm or more.

In the present invention, while the chemical composition of the oxide film is not particularly restricted, Fe₃O₄ as the effective component for the corrosion resistance is contained preferably as described above.

It is not necessary that the oxide film is formed over the entire surface of the soft magnetic component and it is suffice that the film is formed at least to a portion required for corrosion resistance. For example, in the production of a component, while finish cutting is sometimes further applied to a portion of the component after the annealing, the soft magnetic component may include a portion which is a finished portion but not required for corrosion resistance.

### [Production Method of Steel Material]

The steel material of the present invention can be produced by melting steel having the chemical composition described above in accordance with an ordinary melting method and then applying continuous casting and hot rolling. For obtaining a steel material in which a rolling scale defined above is formed on the surface, it is recommended to appropriately control conditions during the hot rolling.

### <Heating Temperature in Hot Rolling>

Heating is applied preferably at a high temperature for completely solid solubilizing alloying components into a matrix phase. However, if the temperature is excessively high, ferrite crystal particles are partially coarsened remarkably to deteriorate the cold forgeability during forming of the component. Accordingly, heating is preferably applied at 1200° C. or lower and more preferably at 1150° C. or lower. On the other hand, if the heating temperature is excessively low, a ferrite phase may be formed locally to possibly cause cracking during the rolling. Further, since the roll load increases during rolling to increase the burden on the facility and deteriorate the productivity, the hot rolling is performed while heating, preferably, at 950° C. or higher.

### <Temperature for Finish Rolling>

If the temperature for finish rolling in the hot rolling is excessively low, the metal microstructure tends to be refined to generate abnormal partial grain growth (GG) in the subsequent cooling process or in the annealing process after forming the component. The GG generation portion causes roughening during cold forging and variation of the magnetic properties. Accordingly, for arranging the size of the crystal particles, the rolling is completed at a temperature for finishing rolling, preferably, of 850° C. or higher (more preferably, 875° C. or higher). The upper limit for the rolling temperature in the finish rolling is about 1100° C. depending on the heating temperature.

<Coiling Temperature after Hot Rolling>

In coiling as the final step of the hot rolling, the coiling temperature is preferably set to 875° C. or lower in order to preferentially grow FeO of excellent pickling property as the rolling scale component. The coiling temperature is more preferably 850° C. or lower. Means for realizing such a coiling temperature includes, for example, increase of the flow rate of cooling water in a water cooling zone for component. On the other hand, if the coiling temperature is low, a hot strength of a rolled material increases making the coiling work difficult. In addition, in the same manner as in the finish rolling temperature, the cold forgeability and the magnetic properties are deteriorated and FeO is decomposed due to the refinement of the microstructure. Accordingly, the coiling temperature is preferably 700° C. or higher and, more preferably, 750° C. or higher.

### <Cooling Rate After Coiling>

After the coiling, an average cooling rate on a conveyor after the hot rolling (after coiling) to 600° C. is preferably 4° C./sec or more so that FeO in the rolling scale is not found by decomposition to form Fe₃O₄ and further. The average cooling rate is more preferably 5.0° C./sec or more, more preferably, 6.0° C./sec or more. On other hand, the upper limit for the average cooling rate is preferably 10° C./sec or less while considering the reduction of atom vacancy in the matrix. It is more preferably, it is 8.0° C./sec or less.

Means for attaining the average cooling rate includes, for example, adjustment of the conveyor speed thereby spacing a coarse part and a dense part of a wire rod on the conveyor and supply of a blow at an appropriate intensity to the coarse part and the dense part. In addition, the cooling rate can also be attained by dipping the wire rod into a water bath, oil bath, a salt bath, etc. controlled for the temperature.

### [Production Method for Soft Magnetic Component]

The soft magnetic component of the present invention can be produced by applying secondary working and component working to the steel material (rolled material) and then applying annealing to be described later. Specifically, the method includes applying pickling to the rolled material after the hot rolling, forming a lubrication film, and then applying wire drawing and, subsequently, applying cold forging to form a component. The component forming can be performed also by cutting and cold bar finishing. While the annealing is applied subsequently, it is important that the annealing is performed under the following conditions (annealing atmosphere, heating temperature, and time) for forming a defined thin oxide film to the surface of the component. Each of the conditions is to be described specifically.

### <Annealing Atmosphere: Oxygen Concentration of 1.0 Ppm by Volume or Less>

In the annealing, the thickness of the oxide film can be controlled thinly by strictly controlling the oxygen concentration in the annealing atmosphere in addition to the temperature control described below. In the present invention, an oxide film can be formed thinly to the surface of the component by controlling the oxygen concentration to 1.0 ppm by volume or less in the annealing atmosphere. Specific annealing atmosphere includes, for example, an atmosphere of high purity hydrogen, nitrogen, etc. The annealing atmosphere described above may also be an Ar atmosphere at an oxygen concentration of 1.0 ppm by volume or less using an Ar gas at a high purity. The oxygen concentration is preferably 0.5 ppm by volume or less and, more preferably, 0.3 ppm by volume or less. With a viewpoint of forming the oxide film, the lower limit for the oxygen concentration is about 0.1 ppm by volume.

### <Heating Temperature for Annealing (Annealing Temperature): 600 to 1200° C.>

If the annealing temperature is excessively low, strains generated in the forging or cutting cannot be removed, and growing of the crystal particles is also insufficient to deteriorate the magnetic properties. Further, the oxide film is not formed on the surface layer. Accordingly, the annealing temperature is set to 600° C. or higher in the present invention. It is preferably 700° C. or higher. On the other hand, if the annealing temperature is excessively high, the oxide film grows thickly to deteriorate the adhesiveness with the base material and fine cracks are formed in the oxide film to deteriorate the corrosion resistance as described above. Further, this also deteriorates the mass productivity such as the cost of electric power and furnace wall durability. Accordingly, the annealing temperature is set to 1200° C. or lower. The annealing temperature is preferably 1100° C. or lower, more preferably, 1000° C. or lower and, further preferably, 950° C. or lower.

### <Heating Time for Annealing (Annealing Time): One Hour or More and 20 Hours or Less>

If the annealing time is excessively short, annealing becomes insufficient and oxide film cannot be formed uniformly even when the annealing temperature is set to a somewhat high level. Accordingly, the annealing time is defined as one hour or more. It is preferably two hours or more. However, if the annealing time is excessively long, since the thickness of the oxide film increases excessively and the productivity is deteriorated, the annealing time is defined as 20 hours or less. It is preferably 10 hours or less.

During cooling after the annealing, if the cooling rate is excessively high, magnetic properties are deteriorated by strains generated during the cooling. Further, for increasing the proportion of Fe₃O₄ having particularly high corrosion resistance in the composition of the oxide film formed by the annealing, it is preferred to form Fe₃O₄ by FeO decomposing reaction by lowering the cooling rate. With the viewpoints described above, the average cooling rate after the annealing to 300° C. is preferably defined as 200° C./Hr (time) or less. It is more preferably 150° C./Hr or less. On the other hand, if the average cooling rate in the temperature region is excessively low, since the productivity is hindered remarkably, it is preferred that cooling is applied at 50° C./Hr or more.

The present application claims the benefit of a priority right based on Japanese Patent Application No. 2013-074949 filed on Mar. 29, 2013. The entire contents of the specification of the Japanese Patent Application No. 2013-074949 filed on Mar. 29, 2013 are cited herein for reference to the present application.

### EXAMPLE

The present invention is to be described more specifically with reference to examples but the present invention is no way restricted by the following examples and the invention can be practiced with appropriate modifications within the range capable of conforming to the gists described above and to be described later, any of which is incorporated in the technical range of the present invention.

Steels of chemical compositions (remainder consisting of iron and inevitable impurities) shown in Table 1 were melted in accordance with a usual melting method, cast and then applied with hot rolling under the conditions of a heating temperature, a temperature for finish rolling, a coiling temperature after the hot rolling during hot rolling and a cooling rate after a coiling shown in Table 2 to obtain rolled materials (steel sheets) each of 20 mm in diameter. In the Table 2, heating temperature during the hot rolling is shown as “heating temperature”, the coiling temperature after the hot rolling is shown as “coiling temperature”, and the cooling rate after the coiling is shown as “conveyor cooling rate”. Using the rolled materials, rolling scale was evaluated as shown below and a pickling property was evaluated.

TABLE 1
Steel

| material | Chemical composition (mass %), remainder consisting of iron and inevitable impurities | | | | | | | | | | |
|---|---|---|---|---|---|---|---|---|---|---|---|
| No. | C | Si | Mn | P | S | Cr | Al | N | Cu | Ni | Pb |
| A01 | 0.009 | 0.010 | 0.24 | 0.005 | 0.004 | 0.02 | 0.002 | 0.0028 | — | 0.02 | — |
| A02 | 0.008 | 0.002 | 0.10 | 0.004 | 0.006 | 0.01 | 0.003 | 0.0060 | 0.01 | 0.01 | — |
| A03 | 0.005 | 0.008 | 0.75 | 0.007 | 0.005 | 0.01 | 0.003 | 0.0040 | — | 0.01 | — |
| A04 | 0.003 | 0.002 | 0.26 | 0.003 | 0.004 | 0.01 | 0.006 | 0.0010 | 0.30 | 0.40 | — |
| A05 | 0.005 | 0.003 | 0.58 | 0.003 | 0.025 | 0.13 | 0.002 | 0.0014 | 0.31 | 0.32 | — |
| A06 | 0.005 | 0.003 | 0.58 | 0.003 | 0.028 | 0.06 | 0.002 | 0.0015 | 0.11 | 0.12 | — |
| A07 | 0.003 | 0.003 | 0.38 | 0.003 | 0.030 | 0.05 | 0.002 | 0.0014 | 0.31 | 0.31 | — |
| A08 | 0.005 | 0.010 | 0.40 | 0.003 | 0.004 | 0.33 | 0.003 | 0.0023 | 0.01 | 0.01 | — |
| A09 | 0.005 | 0.185 | 0.22 | 0.002 | 0.018 | 0.03 | 0.001 | 0.0076 | 0.02 | 0.02 | 0.10 |
| A10 | 0.004 | 0.003 | 0.26 | 0.008 | 0.027 | 0.01 | 0.002 | 0.0032 | — | — | — |
| A11 | 0.003 | 0.700 | 0.28 | 0.004 | 0.004 | 0.01 | 0.003 | 0.0020 | 0.01 | 0.01 | — |
| B01 | 0.012 | 2.000 | 0.24 | 0.005 | 0.003 | 1.50 | 0.003 | 0.0054 | 0.01 | 0.01 | — |
| B02 | 0.021 | 2.480 | 0.50 | 0.003 | 0.033 | 1.70 | 0.085 | 0.0317 | 0.05 | 0.05 | — |
| B03 | 0.006 | 1.480 | 0.27 | 0.003 | 0.004 | 0.01 | 0.003 | 0.0021 | 0.01 | 0.01 | — |
| B04 | 0.005 | 2.420 | 0.25 | 0.006 | 0.004 | 3.16 | 4.400 | 0.0011 | 0.01 | 0.10 | — |
| B05 | 0.009 | 0.770 | 0.29 | 0.031 | 0.015 | 13.99 | 0.272 | 0.0078 | 0.10 | 0.19 | 0.17 |
| B06 | 0.007 | 2.984 | 0.31 | 0.011 | 0.006 | 7.26 | 0.014 | 0.0046 | — | 0.01 | — |
| B07 | 0.048 | 0.010 | 0.36 | 0.007 | 0.005 | 0.01 | 0.042 | 0.0042 | 0.01 | — | — |
| B08 | 0.108 | 0.180 | 0.48 | 0.013 | 0.015 | 0.08 | 0.024 | 0.0022 | 0.01 | 0.01 | — |
| B09 | 0.007 | 0.009 | 1.50 | 0.006 | 0.100 | 0.01 | 0.002 | 0.0030 | — | 0.01 | — |
| B10 | 0.015 | 0.050 | 0.22 | 0.007 | 0.010 | 2.50 | 0.002 | 0.0030 | 0.70 | 0.65 | — |

### [Evaluation for Rolling Scale]

Rolling scale was evaluated under observation of a Scanning Electron Microscope (SEM) and measurement by X-ray Diffraction (XRD).

A sample cross section preparation method for SEM observation was performed by CP processing (Cross section Polisher Processing using a cross section polisher by an ion etching method) to prevent distortion of the surface layer. The thickness of the rolling scale was observed for the surface layer portion of a diametrical surface (cross sectional surface) of a rolled material at a rate of 200 to 1000 magnifications while identifying the scale by Energy Dispersive X-ray spectrometry (EDX). The thickness of the rolling scale was measured by photographing three view fields and the average value was determined as “thickness of rolling scale”.

XRD was performed by an X-ray diffraction apparatus RAD-RU300 manufactured by Rigaku Corporation at a target output of Co and using a monochrometer (Kα ray) at 20=15°-110°. The oxide composition (FeO, (Fe, Mn)O, Fe₂O₃, Fe₃O₄, etc.) was identified referring to an ICDD (International Center for Diffraction Data) card. Then, quantitative proportion for each of the components (volume %) was determined based on the peak intensity ratio excluding a Fe peak and the amount of FeO in the rolling scale was determined.

### [Evaluation for Pickling Property of Rolled Material]

First, rolled materials were cut each into 20 mm length to prepare test specimens, an acetone solution containing a vinyl chloride coating material was coated at the ends and a resin tape was wound there around for masking. In a beaker test using an aqueous solution of 15% H₂SO₄, each of the obtained test specimens was used and immersed at a room temperature for one hour while stirring the aqueous solution. Then, appearance was observed after the test. In the appearance observation, a residual area of the rolling scale was confirmed and measured with naked eyes. Then, a value determined as 100×(residual area of rolling scale)/(surface area of test specimen) was defined as “residual area ratio of rolling scale” and the specimens were evaluated for the residual area ratio of the rolling scale as “◯” in a case where the ratio was 0%, as “Δ” in a case where it was more than 0% and less than 10%, and as “x” in a case where it was 10% or more. The cases for “◯” were evaluated as excellent in the pickling property. The results are shown in Table 2.

Then, rolling materials with excellent pickling property, that is, those indicated as “◯” in the column for “evaluation for pickling property” in the following Table 2 were used, applied with pickling under mass production conditions, then deposited with a lubrication film, and then cold finished (corresponding to component forming”, and cut to obtain cold finished steel rods of 16 mm diameter×16 mm length. Further, as another component forming method, columnar test specimens of 10 mm diameter×10 mm length (cut test specimen) were also prepared by a lathe while simulating cutting. The cold finished steel rods and cut test specimens obtained as described above were used and annealed under the conditions shown in Table 3 to obtain components for evaluation. The average cooling rate after the annealing to 300° C. was within a range of 100 to 150° C./Hr.

Then, evaluation for the oxide film and the corrosion resistance were performed by using the components described above. Further, the magnetic properties were evaluated by using the rolled materials described above and preparing the test specimens for evaluation as described below. For examining the effect of presence and absence of the oxide film on the corrosion resistance, corrosion resistance was evaluated by using test specimens of 8 mm diameter×8 mm length obtained by milling the surface layer of a test specimen after the annealing, that is, a specimen from which the oxide film formed by annealing was removed for D14 in the Table 3.

### [Evaluation for Oxide Film]

The oxide film after the annealing was analyzed by observation under a TEM (transmission Electron Microscope)-FIB (Focused Ion Beam). Specimens for TEM observation were prepared as described below. That is, the cut test specimen after the annealing was used and FIB processing was performed by a focused ion beam processing observation equipment FB2000A manufactured by Hitachi Limited, using Ga as an ion source. For protecting the uppermost surface of the specimen, after coating a carbon film by using a high vacuum evaporation device and a FIB device, a specimen piece was sampled by a FIB micro sampling method. The specimen was sampled out from a protrusion portion of unevenness formed by lathe cutting, etc. Then, the sampled piece was subjected to FIB processing in a W(CO)₆ gas, bonded to a Mo mesh by deposited W and sliced to a thickness for allowing TEM observation.

TEM observation was performed as described below by using the specimen for TEM observation obtained as described above. That is, in the TEM observation, the specimen was observed by a field emission transmission electron microscope HF-2000 manufactured by Hitachi Ltd. at a beam diameter of 10 nm and at a rate of 10,000 to 750,000 magnification, and bright view field images were photographed while identifying the composition of the oxide film by EDX analysis using EDX spectrometer Sigma manufactured by Kavex. The thickness of the oxide film was measured by photography for 3-view fields and an average value was determined as “thickness of oxide film”. In the structural analysis of the oxide film, Si was used as a standard specimen and a lattice constant determined from a nano-electron beam diffraction diagram was determined with reference to the value of a JCPDS (Joint Committee of Powder Diffraction Standards) card (error less than 5%). In this embodiment, absence or presence of Fe₃O₄ in the oxide film was confirmed. In the Table 3, it is shown as “present” in a case where Fe₂O₃ is present and as “-” in a case where Fe₃O₄ is not present or cannot be evaluated.

### [Evaluation of Corrosion Resistance]

In a beaker test using an aqueous solution of 1% H₂SO₄, components after the annealing were used and immersed at a room temperature for 24 Hr while stirring the aqueous solution. Then, the appearance was observed and the corrosion loss in weight was measured after the test. In the appearance observation after the test, generation of rust was confirmed and measured with naked eyes, in which the value determined by 100×(rust area)/(surface area of test specimen) was defined as “rust area ratio” and it was judged as “◯” in a case where the rust area ratio was 0%, as “Δ” in a case where it was more than 0% and less than 10%, and as “x” in a case where it was 10% or more. Further, in the measurement of the corrosion loss in weight, a value obtained by dividing the amount of mass change of the test specimen before and after immersion with an initial surface area of the test specimen was determined as “corrosion loss in weight”. Then, a case where the judgement for the rust area ratio is “◯” and the corrosion loss in weight was 40 g/m² or less was evaluated that the corrosion resistance was excellent, that is, it was judged as “◯” in the column for the corrosion resistance in Table 3 and a case not satisfying any one of them was evaluated that corrosion resistance was poor, that is, as “x” in the column for corrosion resistance in the Table 3. No significant difference was found in the result of evaluation for the corrosion resistance between the cold finished component and the cut test piece.

### [Evaluation for Magnetic Properties]

Ring shaped specimens each of 18 mm outer diameter, 10 mm inner diameter, and 3 mm thickness were prepared from the rolled material of 20 mm diameter described above and, after applying annealing under the conditions shown in Table 3, the magnetic properties were evaluated according to JIS C 2504. In the measurement, field coils were wound by 150 turns and detection coils were wound by 25 turns, magnetization curves were drawn by using an automatic magnetization measuring apparatus (BHS-40, manufactured by Riken Corporation) at a room temperature and coercive force and magnetic flux density under applied magnetic field of 400 A/m were determined. Then, those having a coercive force of 80 A/m or less and the magnetic flux density of 1.20T or more were evaluated as excellent in the magnetic properties, that is, as “◯” in the column for the magnetic properties in the Table 3 and those not satisfying any one of them were evaluated that they were poor in the magnetic properties, that is, evaluated as “x” in the column for the magnetic properties in the Table 3.

The results are shown in the Table 3.

TABLE 2

| | | | Finish | | | | | | | | | | | |
|---|---|---|---|---|---|---|---|---|---|---|---|---|---|---|
| | Steel | Heating | rolling | Coiling | Conveyor | Thickness | Oxide composition of rolling scale | | | | | | Residual | |
| Experi- | mate- | temper- | temper- | temper- | cooling | of rolling | | (Fe, | | | | | area ratio | Evaluation |
| ment | rial | ature | ature | ature | rate | scale | FeO | Mn)O | Fe2O3 | Fe3O4 | Others | | of Rolling | for pickling |
| No. | No. | [° C.] | [° C.] | [° C.] | [° C./sec] | [μm] | [%] | [%] | [%] | [%] | [%] | Type | scale | property |
| C01 | A01 | 1100 | 950 | 850 | 6.7 | 8.5 | 49.6 | 25.8 | 2.1 | 22.5 | 0.0 | — | ∘ | ∘ |
| C02 | A02 | 1000 | 975 | 875 | 6.7 | 18.6 | 60.1 | 10.3 | 5.2 | 24.4 | 0.0 | — | ∘ | ∘ |
| C03 | A03 | 1000 | 950 | 850 | 6.7 | 13.5 | 41.1 | 30.5 | 4.6 | 23.8 | 0.0 | — | ∘ | ∘ |
| C04 | A04 | 1000 | 950 | 850 | 6.7 | 21.1 | 43.3 | 25.8 | 4.1 | 26.8 | 0.0 | — | ∘ | ∘ |
| C05 | A05 | 1000 | 950 | 850 | 6.7 | 24.3 | 50.3 | 20 | 2.3 | 27.4 | 0.0 | — | ∘ | ∘ |
| C06 | A06 | 1000 | 950 | 850 | 7.8 | 16.6 | 45.1 | 25.8 | 1.7 | 27.4 | 0.0 | — | ∘ | ∘ |
| C07 | A07 | 1000 | 950 | 850 | 6.7 | 24.3 | 50.7 | 20 | 3.2 | 26.1 | 0.0 | — | ∘ | ∘ |
| C08 | A08 | 1050 | 950 | 875 | 6.7 | 29.9 | 42.1 | 25.8 | 2.6 | 29.5 | 0.0 | — | ∘ | ∘ |
| C09 | A09 | 1000 | 950 | 850 | 8.3 | 10.1 | 50.5 | 20 | 3.3 | 26.2 | 0.0 | — | ∘ | ∘ |
| C10 | A10 | 1000 | 950 | 850 | 6.7 | 6.5 | 52.6 | 20 | 4.3 | 23.1 | 0.0 | — | ∘ | ∘ |
| C11 | A01 | 1000 | 950 | 850 | 6.7 | 7.3 | 43.8 | 25.8 | 5.1 | 25.5 | 0.0 | — | ∘ | ∘ |
| C12 | A11 | 1100 | 975 | 850 | 6.7 | 28.0 | 41.4 | 29.6 | 1.3 | 27.7 | 0.0 | — | ∘ | ∘ |
| D01 | B01 | 1000 | 950 | 850 | 6.7 | 40.1 | 2.5 | 11.9 | 26.5 | 55.9 | 3.2 | Fe2SiO4 | Δ | x |
| D02 | B01 | 950 | 900 | 800 | 2.5 | 32.5 | 0.2 | 1.4 | 44 | 50.9 | 3.5 | Fe2SiO4 | Δ | x |
| D03 | B01 | 1000 | 950 | 850 | 1.7 | 15.1 | 0.5 | 1.2 | 40.7 | 57.0 | 0.6 | Fe2SiO4 | Δ | x |
| D04 | B02 | 1000 | 950 | 850 | 6.7 | 31.8 | 6.3 | 4.2 | 26.3 | 54.9 | 8.3 | FeCr2O4 | x | x |
| D05 | B03 | 1100 | 1050 | 850 | 6.7 | 20.3 | 10.0 | 10.4 | 30.3 | 48.3 | 1.0 | Fe2SiO4 | Δ | x |
| D06 | B04 | 1000 | 950 | 850 | 6.7 | 16.8 | 5.1 | 9.5 | 30.4 | 50.0 | 5.0 | FeCr2O4 | Δ | x |
| D07 | A10 | 1000 | 950 | 850 | 1.7 | 5.8 | 17.3 | 20 | 8.6 | 48.1 | 0.0 | — | Δ | x |
| D03 | A01 | 1000 | 1000 | 950 | 6.7 | 110.2 | 34.1 | 15.3 | 6.3 | 44.3 | 0.0 | — | Δ | x |
| D09 | B05 | 1050 | 950 | 850 | 6.7 | 25.8 | 34.5 | 14.3 | 13.5 | 25.4 | 12.3 | FeCr2O4 | x | x |
| D10 | B06 | 1000 | 950 | 850 | 6.7 | 22.2 | 20.6 | 10.7 | 17.8 | 29.8 | 21.1 | FeCr2O4, | x | x |
| | | | | | | | | | | | | Fe2SiO4 | | |
| D11 | A01 | 1100 | 1000 | 875 | 6.7 | 50.6 | 41.3 | 23.6 | 4.1 | 31.0 | 0.0 | — | ∘ | ∘ |
| D12 | A01 | 1000 | 950 | 850 | 4.0 | 15.2 | 44.4 | 23.1 | 5.3 | 27.2 | 0.0 | — | ∘ | ∘ |
| D13 | A02 | 1000 | 1000 | 875 | 4.0 | 51.3 | 40.2 | 20.3 | 6.1 | 33.4 | 0.0 | — | ∘ | ∘ |
| D14 | A03 | 1000 | 1000 | 850 | 6.7 | 34.3 | 45.3 | 19.6 | 1.2 | 33.9 | 0.0 | — | ∘ | ∘ |
| D15 | B07 | 1000 | 950 | 850 | 1.7 | 18.9 | 0 | 3.9 | 18.7 | 77.4 | 0.0 | — | x | x |
| D16 | B08 | 1000 | 950 | 850 | 6.7 | 15.8 | 46.3 | 6.5 | 3.8 | 43.4 | 0.0 | — | ∘ | ∘ |
| D17 | B09 | 1000 | 950 | 850 | 6.7 | 20.9 | 41.2 | 32.3 | 3.4 | 23.1 | 0.0 | — | ∘ | ∘ |
| D18 | B10 | 1100 | 950 | 850 | 6.7 | 40.3 | 33.9 | 23 | 2.1 | 34.3 | 6.7 | FeCr2O4 | Δ | x |

TABLE 3

| | | | | Oxygen | | | | | | Magnetic properties | | |
|---|---|---|---|---|---|---|---|---|---|---|---|---|
| | Steel | Annealing | Annealing | concentra- | | | | Corrosion | | Magnetic | | |
| Experi- | mate- | temper- | time | tion (Vol ppm) | Oxide film | | Rust | loss in | Evaluation | flux | Coercive | Evaluation |
| ment | rial | ature | (time | in annealing | Thickness | | area | weight | of corrosion | density | force | of magnetic |
| No. | No. | [° C.] | (Hr)) | atmosphere | [nm] | Fe3O4 | ratio | [g/m²] | resistance | [T] | [A/m] | properties |
| C01 | A01 | 850 | 10 | 0.3(H₂) | 11 | Present | ∘ | 30.3 | ∘ | 1.56 | 45.2 | ∘ |
| C02 | A02 | 950 | 3 | 0.3(H₂) | 15 | Present | ∘ | 10.2 | ∘ | 1.60 | 70.0 | ∘ |
| C03 | A03 | 850 | 3 | 0.3(H₂) | 12 | Present | ∘ | 33.2 | ∘ | 1.47 | 79.0 | ∘ |
| C04 | A04 | 950 | 3 | 0.3(H₂) | 18 | Present | ∘ | 19.6 | ∘ | 1.52 | 55.9 | ∘ |
| C05 | A05 | 600 | 3 | 0.3(H₂) | 8 | Present | ∘ | 19.9 | ∘ | 1.52 | 76.0 | ∘ |
| C06 | A06 | 850 | 3 | 0.3(H₂) | 10 | Present | ∘ | 29.9 | ∘ | 1.57 | 79.0 | ∘ |
| C07 | A07 | 850 | 3 | 0.3(H₂) | 13 | Present | ∘ | 27.3 | ∘ | 1.58 | 73.0 | ∘ |
| C08 | A08 | 950 | 3 | 0.3(H₂) | 23 | Present | ∘ | 30.1 | ∘ | 1.55 | 29.3 | ∘ |
| C09 | A09 | 850 | 3 | 0.3(H₂) | 15 | Present | ∘ | 33.6 | ∘ | 1.57 | 46.6 | ∘ |
| C10 | A10 | 700 | 3 | 0.3(H₂) | 6 | Present | ∘ | 38.6 | ∘ | 1.43 | 79.3 | ∘ |
| C11 | A01 | 850 | 3 | 0.7(N₂) | 7 | Present | ∘ | 22.1 | ∘ | 1.55 | 62.3 | ∘ |
| C12 | A11 | 850 | 3 | 0.3(H₂) | 21 | Present | ∘ | 23.4 | ∘ | 1.56 | 43.5 | ∘ |
| D11 | A01 | 1300 | 3 | 0.3(H₂) | 512 | Present | x | 301.1 | x | 1.41 | 37.6 | ∘ |
| D12 | A01 | 850 | 3 | 5.0(Ar) | 667 | Present | x | 111.2 | x | 1.56 | 63.3 | ∘ |
| D13 | A02 | 850 | 3 | Atmo- | 5000 | Present | x | 419.5 | x | 1.35 | 74.3 | ∘ |
| | | | | spheric | | | | | | | | |
| | | | | air | | | | | | | | |
| D14 | A08 | 850 | 3 | 0.3(H₂) | 0 | — | x | 109.2 | x | 1.50 | 38.2 | ∘ |
| D16 | B08 | 850 | 3 | 0.3(H₂) | 18 | — | x | 183.3 | x | 1.06 | 159.2 | x |
| D17 | B09 | 600 | 3 | 0.3(H₂) | 7 | Present | ∘ | 38.4 | ∘ | 1.01 | 221.0 | x |

*Oxide film was cut off after annealing.

In view of the Tables 1 to 3, it can be considered as described below. Since, in Experiments Nos. C01 to C12, they satisfy the defined chemical composition, and defined rolling scale was formed on the surface of rolling material (steel material), it can be seen that excellent pickling property can be ensured. Further, since the rolled materials described above are used and annealed by the defined method, a defined oxide film is formed on the surface of components and they are excellent in the corrosion resistance and also excellent in the magnetic properties.

On the contrary, since chemical composition or the production method is not suitable in other examples than the Experiments Nos. described above and the result was such that the steel materials (rolled materials) were poor in the pickling property, or the corrosion resistance and the magnetic properties of the component were poor. This is to be described specifically as below.

Since the amount of Si was excessive, particularly, in Experiments Nos. D01 to D06 and also the amount of Cr was excessive in D01 to D04 and D06, slight soluble Fe₂SiO₄ or FeCr₂O₄ was formed in the rolling scale to make the pickling property insufficient.

Experiment No. D07 is an experiment in which air cooling was not performed during conveyor cooling after the hot rolling and the cooling rate after coiling was low, and Experiment No. D08 is an example in which the coiling temperature after the hot rolling was high. In any of the examples, the amount of FeO in the rolling scale was lowered to deteriorate the pickling property.

In Experiments Nos. D09 and D10, since the amount of Cr was remarkably excessive, slightly soluble FeCr₂O₄ was formed in the rolling scale to deteriorate the pickling property.

In Experiment No. D15, since air cooling was not performed during the conveyor cooling after the hot rolling and cooling rate after the coiling was low, FeO in the rolling scale was insufficient to deteriorate the pickling property.

In Experiment No. D18, since the amount of Cr was excessive and Cu and Ni were also contained excessively, slightly soluble scale (particularly, FeCr₂O₄) was formed in the rolling scale to deteriorate the pickling property.

In Experiments Nos. D11 to D13, since the annealing conditions were not appropriate, the thickness of the oxide film after the annealing exceeded the upper limit defined in the present invention and the corrosion resistance was insufficient. Specifically, since the annealing temperature was excessively high in Experiment No. D11, the oxide film was formed thickly making the corrosion resistance insufficient.

Experiment No. D12 is an example of performing the annealing in an Ar atmosphere at an oxygen concentration of 5.0 ppm by volume and D13 is an example of performing annealing in atmospheric air. In the examples, since the oxygen concentration in the annealing atmosphere is excessively high, the oxide film was formed thickly and the corrosion resistance was insufficient.

Experiment No. D14 is an example of removing the oxide layer on the surface by cutting after the annealing. Since the oxide film is not present on the surface of the component, no excellent corrosion resistance could be obtained.

In Experiment No. D16, since the amount of C was large, both the corrosion resistance and the magnetic properties were deteriorated as a result.

In Experiment No. D17, since the amount of Mn and the amount of S were excessive, no excellent magnetic properties could be obtained.

### INDUSTRIAL APPLICABILITY

The steel material for soft magnetic component of the present invention is useful as core materials, magnetic shield materials and actuator materials for electromagnetic valves, solenoids, relays, etc. used in various types of electromagnetic components (soft magnetic components) applied, for example, to automobiles, electric cars, and ships. In particular, the steel material exhibits excellent properties, particularly, in an environment requiring corrosion resistance.

1. A steel material for a soft magnetic component with excellent pickling property satisfying:
C: 0.001 to 0.025% (mass % identical here hereinafter for chemical components),
Si: more than 0% and less than 1.0%,
Mn: 0.1 to 1.0%,
P: more than 0% and 0.030% or less
S: more than 0% and 0.08% or less,
Cr: more than 0% and less than 0.5%,
Al: more than 0% and 0.010% or less, and
N: more than 0% and 0.01% or less, with
the remainder consisting of iron and inevitable impurities in which a rolling scale containing 40 to 80 vol % of FeO is formed on the surface of the steel material.

2. The steel material for a soft magnetic component according to claim 1, wherein
one or more elements belonging to at least one of the following (a) and (b) is further contained:
(a) one or more elements selected from the group consisting of Cu: more than 0% and 0.5% or less and Ni: more than 0% and 0.5% or less, and
(b) Pb: more than 0% and 1.0% or less.

3. A soft magnetic component with excellent corrosion resistance and magnetic properties obtained by using the steel material for the soft magnetic component according to claim 1, where
an oxide film of 5 to 30 nm thickness is formed on the surface of the component.

4. A method of producing the soft magnetic component with excellent corrosion resistance and magnetic properties according to claim 3, the method including:
forming a component using the steel material for the soft magnetic component and then performing annealing under the following conditions:
(Annealing condition)
Annealing atmosphere: oxygen concentration of 1.0 ppm by volume or less,
Annealing temperature: 600 to 1200° C., and
Annealing time: one hour or more but 20 hours or less.
